(19) United States
(12) Patent Application Publication
(10) Pub. No.: US 2010/0274553 A1
(43) Pub. Date: Oct. 28, 2010

(54) Multi-Languages IDN System

(76) Inventor: Netanel Raisch, Psagot (IL)

Correspondence Address: Mr. Netanel Raisch, Psagot 56, Psagot, 90624, IL

(21) Appl. No.: 12/762,343

(22) Filed: Apr. 18, 2010

(30) Foreign Application Priority Data
Apr. 27, 2009 (IL) 198,246

(51) Int. Cl. G06F 17/28

(52) U.S. Cl. 704/2; 704/E11.001

(57) ABSTRACT

This present invention includes a system for making International Domain Name use significantly easier. The system automatically switches between strings in a local language and a corresponding TLD string like “.com”. The system avoids the need to switch between languages during the IDN typing and is ideal for computer and hand-held web browsers used in countries with non-English local languages.

### FIELD OF THE INVENTION

The present invention relates to Domain Name Services used to resolve network domain names into corresponding network addresses. More particularly, the invention relates to an alternative or modified Domain Name Service that accepts domain names provided in many different encoding formats, not just ASCII.

### BACKGROUND OF THE INVENTION

The Internet today relies entirely on the Domain Name System to resolve human-readable names into numeric IP addresses and vice versa. The Domain Name System (DNS) is still based on a subset of Latin alphabet, thus it still is mainly in English. To provide universality, e-mail addresses, Web addresses, and other Internet addressing formats adopt the American Standard Code for Information Interchange (ASCII) as the global standard to guarantee interoperation. Till the last few years no provision was made to allow for Web addresses to be in a non-ASCII native language. The implication is that any user of the Internet has to have some basic knowledge of ASCII characters.

However, since domain names are presented to users in URLs, and corresponding arrangements in other protocols, a demand rapidly arose to permit domain names in applications that use characters other than those of the very restrictive, ASCII-subset. The effort to do this rapidly became known as “multilingual domain names”, although that is a misnomer, since the DNS deals only with characters and identifier strings. There has been little actual interest in what would actually be a “multilingual name” i.e., a name that contains components from more than one language, but only the use of strings conforming to different languages in the context of the DNS has been addressed.

In the prior-art, attempts were made to allow Internet users to type domain names in their local language. As a result for these attempts a solution was devised, known as “Internationalized Domain Names” (IDNs). IDNs are domain/host names that are represented by native language, non-ASCII characters. The native language domain name is followed by the Top Level Domain (TLD), such as .info, .com, or .org. IDNs are domain names represented by local language characters. Such domain names can contain characters with diacritical marks as required by many European languages, or characters from non-Latin scripts (for example, Hebrew or Chinese). IDNs made the domain name label as it is displayed and viewed by the end user different from that transmitted in the DNS. Thanks to IDNs Internet users are now able to type domain names, at least partially, in their local language. With IDNs, an Internet user can type the localized characters in front of the “dot”.

Following are examples for two IDNs URL addresses in the Hebrew language:

www. [symbol] .com
www. [symbol] .com

In this form, the Hebrew characters come before the “dot” and after the “dot” are the extensions or TLDs. Following are examples of three types of TLDs:
Global TLD (gTLD) refers to TLDs which do not give any meaning of location or country e.g.: .com, .net, .biz etc.
Country Code TLD (ccTLD) refers to TLDs that are specific extensions to a country e.g.: .jp, .co.il, .de etc.
Initial TLD (iTLD) refers to the string of characters before the “dot” after which the IDN in a local language is provided, such as the popular “www.” as shown in the examples hereinabove.

However, Internet users still have to type the extensions in English while typing the IDN in a local language (e.g., Hebrew). This requires the end user to switch between two different languages while typing the entire URL address (see FIG. 2).

In view of these and other issues, it would be highly desirable to have a technique allowing the characters to be typed in a local language only.

Therefore it is an object of the present invention to provide a system and method for allowing end users to type the entire domain name in a local language only.

It is another object of the present invention to provide a system and method which are capable to convert an entire domain name typed in a local language into an acceptable IDN format.

Other objects and advantages of the invention will become apparent as the description proceeds.

### SUMMARY OF THE INVENTION

The invention relates to a method for converting unconventional URL addresses written in a local language into a standard IDN form, comprising:
a. Providing a table containing a list of characters in said local language and their corresponding list of characters in a standard TLD form, wherein each item in each of said lists is a string of characters;
b. Providing to a web browser a string of characters in said local language, wherein said string of characters represents a URL address;
c. Searching in said table parts of said string of characters among said list of characters in said local language; and
d. upon finding an identical string in said table, replacing said identical string in said web browser with the corresponding characters in said standard TLD form.

In one embodiment of the invention the method further comprises adding to the web browser a local URL address box for entering the string of characters in the local language. Each string of characters in the list of characters in the standard TLD form can be selected, for instance, from the group consisting of iTLDs, TLDs, gTLDs or ccTLDs.

In another embodiment of the invention the method further comprises allowing modifying the list of characters in the local language by a user. In yet another embodiment the method further comprises allowing modifying the list of characters in the standard TLD form by a user. The list of characters in the local language and their corresponding list of characters in the standard TLD form can be updated by any suitable means, e.g., via the Internet or an update file.

The invention also encompasses a system for converting unconventional URL address written in a local language into a standard IDN form, comprising:
a. Means for generating a table containing a list of characters in said local language and their corresponding list of characters in said standard TLD form, wherein each item in each of said lists is a string of characters;
b. Input means for providing to a web browser a string of characters in said local language, wherein said string of characters represents a URL address;
c. Means for searching in said table at least part of said string of characters among said list of characters in said local language; and
d. Means for replacing said identical string in said web browser with the corresponding characters in said standard TLD form upon finding an identical string in said table.

In one embodiment of the invention the system further comprises means for adding to the web browser a local URL address box for entering the string of characters in the local language.

### BRIEF DESCRIPTION OF THE DRAWINGS

In the drawings:

FIG. 1 schematically illustrates a web browser provided with a URL address typed in a local language form;

FIG. 2 schematically illustrates a web browser provided with a URL address in multi-language form;

FIG. 3 is a conversion table from local language to common Latin form, according to an embodiment of the invention.

### DETAILED DESCRIPTION OF PREFERRED EMBODIMENTS

The present invention relates to a method for locally translating or mapping a string of characters typed in a local language in a web browser into common TLD names via that web browser. According to an embodiment of the invention, a translation table is provided in which lists of TLD names (which are a string of characters in a standard ASCII form) are kept together with lists of string of characters in a local language form (i.e., non English language). FIG. 3 schematically illustrates an example of such a translation table, generally indicated by numeral 4. Preferably, each string of characters in the list of characters in the standard ASCII form of translation table 4 can be any type of TLD, such as iTLDs, TLDs, gTLDs, ccTLDs, etc.

In general, according to an embodiment of the invention user interface software embedded within the web browser examines a presumed TLD name and, if it was typed in the local character set, the software attempts to translate it into the standard ASCII form using the corresponding values in the translation table.

According to an embodiment of the invention, the system converts unconventional URL addresses written in a local language form into a standard IDN form using the translation table. Preferably, the translation table contains a list of characters in the local language and their corresponding list of characters in the standard TLD form, wherein each item in each of the lists is a string of characters.

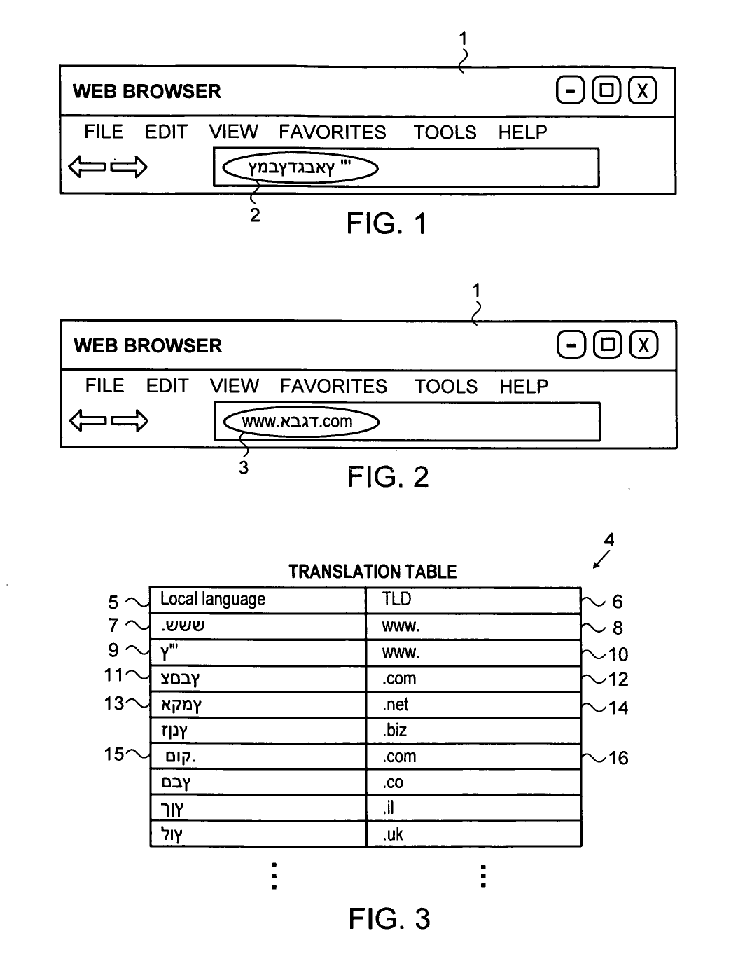

FIG. 1 schematically illustrates a web browser 1 provided with a string of characters which represents a URL address typed in a local language form (surrounded by circle 2). The string is provided to web browser 1 via any suitable input means, such as keyboard. After providing the URL address, the software embedded within web browser 1 searches in the translation table (such as table 4 of FIG. 3) whether part of the provided string of characters (which represents the TLD form in the local language) can be found among the list of characters in the translation table 4. In this example the following URL address was provided to the web browser (in Hebrew letters):

[symbol]

### Wherein:

[symbol] =www. [symbol]
=IDN (i.e., the real local URL representation of the IDN form, no translation required) [symbol]
=.com

Upon finding an identical one or more strings in translation table 4, such as the string [symbol] (9) and string [symbol] (11) then each of the strings (9) and (11) is replaced in the web browser 1 with its corresponding string in the standard TLD form, such as string “www.” (10) and string “.com” (12) correspondingly. As a result, web browser 1 contains a URL address in an acceptable IDN format, as shown in FIG. 2 (surrounded by circle 3). Preferably, the system of the present invention identifies the IDN form as a local language text between the first “dot” and the last “dot” of the URL address according to the common URL address rules. Whether it was typed as a character which represent a real dot (i.e., “.”), or it was typed as local language character (e.g., [symbol] ).

Accordingly, the method of the present invention avoids the need to switch between two languages while typing a URL address in an IDN format. Instead of typing: www. [symbol] .com, using the method of the present invention the user type the entire URL address in a single local language, and no switch between languages is required while typing.

According to another embodiment of the invention, the web browser is provided with an additional local URL address box dedicated for entering the string of characters in the local language, such as a toolbar (not shown) or other suitable form.

According to an embodiment of the invention, the lists of characters in the translation table 4, either the local or the standard TLD one can be updated or modified either manually or via a file by a user or via the Internet.

IDNA is entirely a client-side protocol. It works by providing labels to the DNS in a special format (so-called “ACE”). When labels in that format are encountered, they are transformed, by the client, back into internationalized (normally Unicode) characters.

As mentioned above, users may want to maintain a translation table that contains a list of TLDs and that maps between them and locally-desirable names, such as [symbol] (15) and its corresponding TLD form “.com” (16), [symbol] (7) and its corresponding TLD form “www.” (8), [symbol] (13) and its corresponding TLD form “.net” (14), etc. These might be the names (or locally-standard abbreviations) by which the relevant countries are known locally (whether in ASCII characters or others). According to an embodiment of the invention, the software embedded within browser 1, further contains means to allow a user to input one or more particular TLD names either in the local language or in standard form without special tagging or problems, as it known to a person skilled in the art. Of course, this should be done with some care on the part of the application designer to ensure that local forms do not conflict with the actual TLD names.

When DNS names are received by these client programs, the TLD labels is mapped to local form before the IDNA is applied to the rest of the name. When names are received from users, local TLD names are mapped to the global ones before being passed into IDNA or for other DNS processing.

Each function represented by a TLD, a country, generic registrations, or purpose-specific registrations, can be represented in the local language and character set as needed; and, for countries with many languages, or users living, working, or visiting countries where their language was not dominant, “local” can be defined in terms of the needs or wishes of each particular user.

The tables for mapping between local names and TLD names can be locally determined, and differ from one locale to another, as long as users understand that international interchange of names required using the standard forms. That understanding can be assisted by software.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for converting unconventional URL addresses written in a local language into a standard IDN form, comprising:
a. Providing a table containing a list of characters in said local language and their corresponding list of characters in a standard TLD form, wherein each item in each of said lists is a string of characters;
b. Providing to a web browser a string of characters in said local language, wherein said string of characters represents a URL address;
c. Searching in said table parts of said string of characters among said list of characters in said local language; and
d. upon finding an identical string in said table, replacing said identical string in said web browser with the corresponding characters in said standard TLD form.

2. A method according to claim 1, further comprising adding to the web browser a local URL address box for entering the string of characters in the local language.

3. A method according to claim 1, wherein each string of characters in the list of characters in the standard TLD form is selected from the group consisting of iTLDs, TLDs, gTLDs or ccTLDs.

4. A method according to claim 1, wherein the local language is a non-English language.

5. A method according to claim 1, further comprising allowing modifying the list of characters in the local language by a user.

6. A method according to claim 1, further comprising allowing modifying the list of characters in the standard TLD form by a user.

7. A method according to claim 1, wherein the list of characters in the local language and their corresponding list of characters in the standard TLD form are updated via the Internet or an update file.

8. A system for converting unconventional URL address written in a local language into a standard IDN form, comprising:
a. Means for generating a table containing a list of characters in said local language and their corresponding list of characters in said standard TLD form, wherein each item in each of said lists is a string of characters;
b. Input means for providing to a web browser a string of characters in said local language, wherein said string of characters represents a URL address;
c. Means for searching in said table at least part of said string of characters among said list of characters in said local language; and
d. Means for replacing said identical string in said web browser with the corresponding characters in said standard TLD form upon finding an identical string in said table.

9. A system according to claim 8, further comprising means for adding to the web browser a local URL address box for entering the string of characters in the local language.

10. A system according to claim 8, in which each string of characters in the list of characters in the standard TLD form is selected from the group consisting of iTLDs, TLDs, gTLDs or ccTLDs.

11. A system according to claim 8, in which the local language is a non-English language.

12. A system according to claim 8, further comprising means for allowing modifying the list of characters in the local language by a user.

13. A system according to claim 8, further comprising means for allowing modifying the list of characters in the standard TLD form by a user.

14. A system according to claim 8, in which the list of characters in the local language and their corresponding list of characters in the standard TLD form are updated via the Internet or an update file.
